(19) United States
(12) Patent Application Publication
(10) Pub. No.: US 2004/0206679 A1
(43) Pub. Date: Oct. 21, 2004

(54) Strainer assembly

(76) Inventor: James M. Bleigh, Olathe, KS (US)

Correspondence Address: Womble Carlyle Sandridge & Rice PLLC, P.O. Box 7037, Atlanta, GA, 30357-0037, US

(21) Appl. No.: 10/796,852

(22) Filed: Mar. 9, 2004

Related U.S. Application Data
(63) Continuation-in-part of application No. 10/722,382, filed on Nov. 25, 2003, now abandoned.
(60) Provisional application No. 60/428,851, filed on Nov. 25, 2002.

(51) Int. Cl. B01D 35/16

(52) U.S. Cl. 210/97; 210/335; 210/459; 210/456

(57) ABSTRACT

A suction strainer includes a plurality of strainer bodies in flow communication with suction inlet of a pump. The strainer bodies include flow control apertures that are sized and aligned with the suction exit of the bodies to allow for control of the flow characteristics of the fluid being suctioned through the bodies. The flow control apertures can be sized to provide collective aperture areas that increase distally away from the suction exit of the body and the suction inlet of the pump.

### CROSS-REFERENCE TO RELATED APPLICATIONS

This application is a continuation-in-part of U.S. patent application Ser. No. 10/722,382, filed Nov. 25, 2003, and which claimed the benefit of the filing date of U.S. Provisional Patent Application Serial No. 60/428,851, filed on Nov. 25, 2002. U.S. patent application Ser. No. 10/722,382 and U.S. Provisional Patent Application Serial No. 60/428,851 are hereby incorporated by reference in their entireties as if fully set forth herein.

### TECHNICAL FIELD

The present invention generally relates to the field of strainers, and more particularly to the field of strainers employed with suction pumps.

### BACKGROUND

Water intake systems in which water is drawn from a natural or manmade body of water through suction pumps often create suction pressures that draw debris and aquatic animals to the system inlets. In some cases, aquatic animals, unable to overcome the suction of the intake system, can be sucked into or trapped at the system inlet. In response to these circumstances, the Environmental Protection Agency promulgated Rule 316b, which, in part, mandates that the intake velocity at an intake surface be small enough to allow aquatic animals to swim away from the intake surface. In order for an intake system to meet this requirement, it may or may not be enough to have the “average” approach velocity for each intake surface meet a specified intake velocity; rather, it may require that the approach velocity “at given any point” along the intake surface not exceed desired or mandated limits or approach velocities.

### SUMMARY

Briefly described, the present invention generally is directed to a strainer assembly having flow control apertures that can affect the characteristics of the flow of fluid drawn through the assembly when a negative pressure or suction is applied. The strainer assembly includes a strainer body having a primary opening through which fluid exits the strainer body and a series of flow control apertures through which fluid passes before exiting the strainer body. The flow control apertures can be sized and distributed along the strainer body so as to allow the fluid passing through the aperture to achieve a uniform approach velocity through all the surface and/or to not exceed a target approach velocity. This can be achieved by designing the area of a given flow control aperture such that it is greater than the area of each flow control aperture control that is closer to or proximally aligned with the primary opening. Alternatively, the positioning of the flow control apertures may be such that the collective area of flow control apertures in a given area of a strainer body or at a given distance from the primary opening is greater than the collective area of flow control apertures in a similarly sized area of the body that is closer to or proximally aligned with the primary opening.

In one embodiment, the present invention includes a strainer assembly having one or more strainer bodies defining an internal chamber and having a primary opening formed therein. The strainer body includes a wall encompassing at least a portion of the internal chamber. A series of flow control apertures is formed in a wall of the strainer body and includes at least a first flow control aperture proximate to the primary opening and a second flow control aperture distal to the primary opening. The area of the second flow control aperture is greater than the area of the first flow control aperture. Indeed, when the series includes more than two flow control apertures extending along the body away from the primary opening, the area of each flow control aperture can be greater than the area of each of those apertures that are closer to or proximal with the primary opening. Also, the flow control apertures can be covered by screen, which can limit the size of solid matter flowing into the strainer body. The strainer body can be formed, in part, by one or more flow control plates having flow control apertures formed therein. For instance, the primary opening can be formed in a flow control plate and have a plurality of flow control aperture series radially aligned therewith. A second flow control plate also can be provided spaced from the first plate and include flow control apertures and a secondary opening through which fluid flows into the body.

In accordance with the present invention, the strainer assembly can include one or more strainer bodies with both a primary opening, through which fluid exits the body, and a secondary opening, through which fluid enters the strainer body from another strainer body. The strainer body includes a first flow control plate in which is formed the primary opening and a first plurality of flow control apertures. The collective area of flow control apertures in any defined unit area of the flow control plate increases distally from the primary opening. In other words, for a given area on the flow control plate, the combined area of the flow control apertures in that given area is greater than the combined area of flow control apertures in another given area of equal size that is located closer to or proximal with the primary opening. The strainer body also includes a second flow control plate mounted adjacent to the first flow control plate and having a secondary opening and a second plurality of flow control apertures formed therein. Again, the collective area of flow control apertures in any defined unit area of second flow control plate increases distally from the secondary opening. A rim can be disposed between the first and second flow control plates and may itself have rim flow control apertures formed therein. One or more screens can extend across the flow control apertures on the flow control plates.

The present invention also is directed to a suction strainer system for connection to a suction inlet of a pump. The suction strainer system can include one or more strainer assemblies in flow communication with a suction inlet of a pump. At least one of the strainer assemblies includes a strainer body defining an internal chamber and having a primary opening formed therein through which fluid exits the strainer body toward the suction inlet. The wall of the strainer body encompasses at least a portion of the internal chamber and includes a plurality of flow control apertures formed therein. The collective area of flow control apertures for any defined unit area of the wall increases distally from the primary opening. For any given area of the wall, the total area of the flow control apertures in that area is greater than the total area of flow control apertures in an area of identical size that is closer to the primary opening. The plurality of strainer assemblies may be sequentially aligned along a flow line leading to the suction inlet. In one embodiment, the flow line leading to the suction inlet is formed in part by the internal chambers of the strainer bodies, which are aligned such that one empties into another toward the suction inlet. Screen may cover one or more of the flow control apertures of the strainer bodies so as to limit the size and amount of solids material passing therethrough. In one particular embodiment, the overall or aggregate area of the flow control apertures in a given strainer body is greater than the overall or aggregate area of the flow control apertures in other individual strainer bodies that are closer to or proximally aligned with the suction inlet of the pump. In other words, the aggregate area of flow control apertures in each strainer body increases from one strainer body to the next distally from the suction inlet.

These and other aspects of the present invention are set forth in greater detail in the detailed description and the drawings, which are briefly described as follows.

### BRIEF DESCRIPTION OF THE DRAWINGS

FIG. 1 is a schematic, side elevational view of a strainer assembly encompassing aspects of the present invention.

FIG. 2 is a cutaway view of the section 2 of the strainer assembly of FIG. 1 taken along line 2-2.

FIG. 3 is a partial exploded perspective view of the strainer assembly of FIG. 1.

FIG. 4 is a schematic top view of a suction strainer system encompassing aspects of the present invention.

FIG. 5 is a schematic top view of another suction strainer system encompassing aspects of the present invention.

### DETAILED DESCRIPTION

Referring now in greater detail to the drawings, in which like numerals represent like components throughout the several views, FIG. 1 discloses a strainer assembly 20 that encompasses aspects of the present invention. The strainer assembly 20 includes a plurality of strainer bodies 21 that are in flow communication with the suction inlet 40 of a suction pump and with a fluid, such as water, generally surrounding the strainer assembly 20. The strainer assembly 20 can be completely or partially submersed in the fluid, which can be, for example, water in a lake, river, pond, or tank and provide intake surfaces for the suction pump. The strainer assembly 20 includes flow control mechanisms, such as flow control plates 30 and 32 and flow control apertures 51, that can regulate the velocity, volume, pressure, and/or flowrate of the fluid drawn into the strainer 20 at a given point along the intake surface.

In the instance where the strainer assembly 20 is disposed in a body of water, the intake velocity of the water entering the strainer bodies 21 can be regulated by the flow control mechanisms such that the water's intake velocity is low enough for aquatic animals to swim away from the surface of the strainer bodies 21, thus avoiding impingement of the aquatic animals on the intake surfaces and possibly clogging the system. However, the suction strainers, strainer assemblies and flow control mechanisms set forth herein can be used in other combinations and applications where it is desired to control one or more characteristics of flow through a strainer structure. Even though the distances vary between the suction inlet 40 and the different parts of the strainer assembly 20, the flow control mechanisms provided in the strainer bodies 21 can provide for a uniform flow across the entire strainer assembly 20 and/or across each individual strainer body 21. As used herein, the term “uniform flow” can encompass one or more of the pressure, velocity, and flowrate of a fluid passing through the parts of the strainer assembly 20.

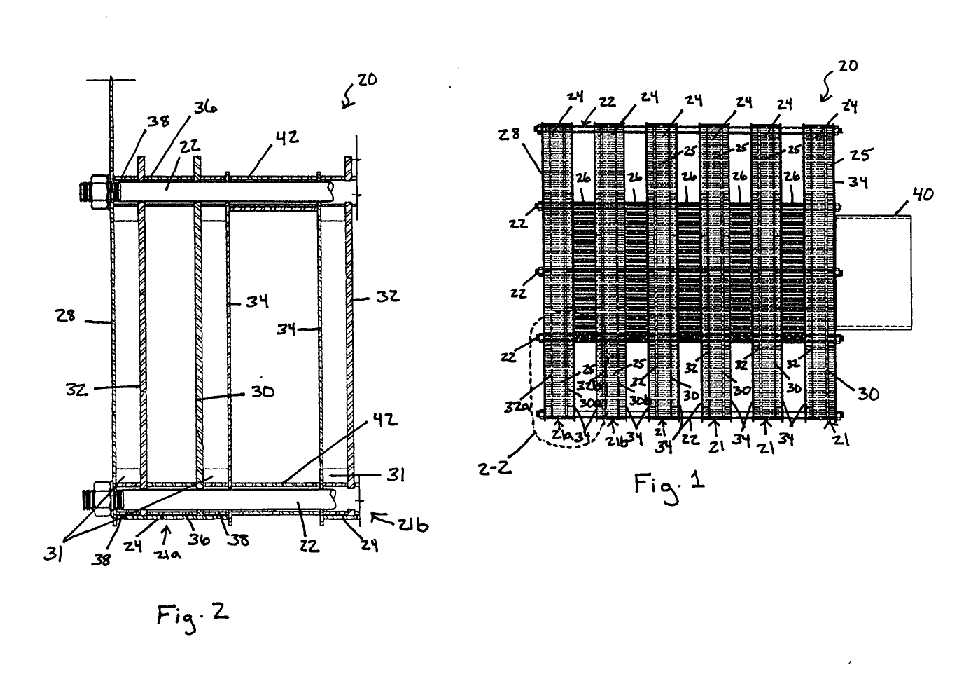

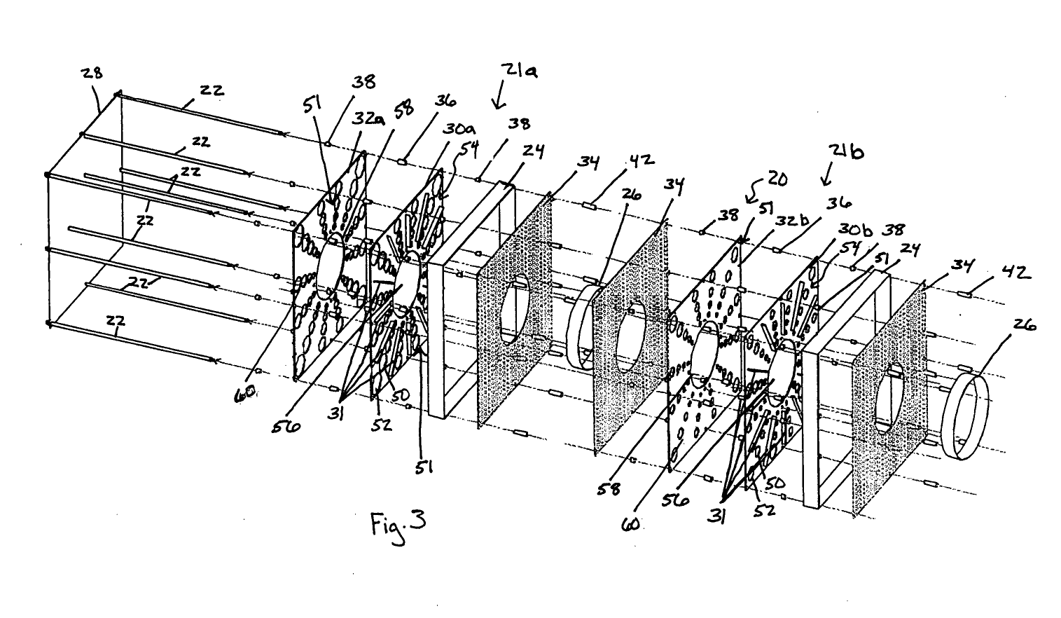

As shown in FIGS. 1-3, the strainer assembly 20 includes a plurality of strainer bodies 21 that are sequentially aligned to form a flow line leading to suction inlet 40. Each strainer body 21 generally has a plurality of holes formed therein through which fluid can be drawn from outside the strainer body 21 into the internal chamber defined by the strainer body 21 and through the flow line leading to the suction inlet 40 of the suction pump that is in flow communication with the strainer assembly 20. The flow line leading to the suction inlet is made up of the internal chambers of each strainer body 21 and the gap rims 26 that are disposed between the strainer bodies 21.

Each strainer body 21 generally includes a first flow control plate 30 and a second flow control plate 32 that are separated from each other by plate spacers 36 and covered along their peripheries by a rim 24 spanning between the flow control plates. The rim 24 of each strainer body 21 may be solid or include a plurality of holes 25, such as exists with perforated plates, through which fluid can pass into the internal chamber of the strainer body 21. The holes 25 can be either simply filtering holes that limit the size of solids drawn into the strainer body 21 or flow control mechanisms that are sized and aligned so as to regulate the flow characteristics of the fluid being drawn into the strainer body 21.

Each first flow control plate 30 of the strainer bodies 21 generally has a primary opening 56 and a plurality of flow control apertures 51 formed therein. Likewise, each second flow control plates 32 of the strainer bodies 21 generally has a secondary opening 58 that is surrounded by flow control apertures 51. The flow control apertures 51 formed on the first control plates can be arranged in series 54, each of which includes a plurality of flow control apertures 51. These series 54 can extend radially from the primary opening across the surface of the first flow control plates 30. Each flow control aperture 51 in each series 54 has an area that is greater than the flow control apertures 51 that are closer to the primary opening 56. In other words, the area of the flow control apertures 51 in the series 54 increases distally from the primary opening 56. For example, first flow control aperture 50 is closer to primary opening 56 and has a smaller area than second flow control aperture 52. In an alternative embodiment, the size of each flow control aperture 51 can be the same as or smaller than other apertures that are proximal or closer to the primary opening 56. In this instance, the number of apertures can increase extending distally from the primary opening so that the aggregate or total area of the flow control apertures still increases distally from the primary opening. Furthermore, in a given defined unit area at any given distance from the center of the primary opening 56 the aggregate area of flow control apertures is the same in every direction. As used herein, the term “defined unit area” refers to an area of an arbitrarily selected size selected for comparison of the collective areas of flow control apertures on two different locations on the wall or flow control plate of the strainer body. Since the negative pressure generated by the suction pump tends to decrease distally or farther from the primary opening 56, the distally increasing collective area of the flow control apertures 51 can provide for a uniform, or otherwise controlled, flow of fluid into the strainer body 21.

The second flow control plates 32 are disposed upstream of the first flow control plates 30 that are within the same strainer bodies 21. Each second flow control plate 32 includes a secondary opening 58 formed therein through which fluid enters the particular strainer body 21 from the upstream bodies or the end of the strainer assembly 20. The series 60 of flow control apertures 51 are radially aligned around the secondary opening 58 in a similar fashion to the alignment of the series 54 of flow control apertures 51 on the first flow control plates 30.

As shown in FIG. 3, the total area of the flow control apertures 51 on first flow control plate 30a is greater than the total area of the flow control apertures 51 on first flow control plate 30b. Likewise, the total area of the flow control apertures 51 on second flow control plate 32a is greater than the collective area of the flow control apertures 51 on second flow control plate 32b. The flow control apertures 51 in strainer body 21a are larger than the apertures 51 in strainer body 21b because strainer body 21a is farther away from suction inlet 40. Therefore, in the embodiment shown in FIG. 3, the aggregate areas of flow control apertures 51 on the strainer bodies increase distally from the suction inlet 40. The increase in flow control aperture areas from one strainer body to the next can provide a uniform flow across the entire span of the strainer assembly 20.

The screen plates 34 are disposed on the outside of each strainer body 21. The screen plates 34 are aligned to allow fluid to enter the strainer bodies 21, but limit the solids that enter the bodies 21. Each screen plate 34 is separated from the flow control surface of the adjacent flow control plate by disk spacers 38 and standoffs 31, which are formed on the flow control plates 30 and 32. The screen plates 34 can be comprised of perforated plates, wire, interwoven mesh or other suitable filter media. In applications wherein filtering is not an issue, the screen plates need not be included in the strainer bodies.

The strainer assembly 20, as shown, is held together by tension rods 22, which are disposed through openings in every flow control plate, screen plate and end plate in the strainer 20. The tension rods 22 can also serve to support the strainer bodies 21 by connecting them to a support structure, such as to end plate(s) 28 on one or both ends of the strainer assembly 20, which, in some embodiments, is a structural member designed to support the weight of all or a portion of the strainer assembly 20. The tension rods 22 can be secured in place by welding or fasteners, such as nuts. In another embodiment, all components of the strainer assembly 20 are welded together. Tension rods 22 may or may not be included in such an embodiment. In some embodiments, the size of the strainer assembly 20 can be quite substantial thereby calling for support members, such as the tension rods 22, to be provided. In one particular embodiment, the strainer assembly 20 has strainer bodies 21 that are approximately 10 to 12 feet in diameter, or square, for use in conjunction with the cooling system of a pressurized water reactor nuclear plant. With strainer bodies 21 of this size, tension rods 22 can contribute substantially to the overall support of the strainer assembly 20.

The end plate 28 caps the end of the strainer assembly 20 and can form a portion of the end suction strainer 21a. The end plate 28 can be solid, wire mesh, or a perforated plate, depending upon the application and the flow characteristics of the strainer 20.

The screens 34, rims 24, rods 22, end plates 28, first control plates 30, second control plates 32, gap disks 26 and the other portions of the strainer assembly 20 can be formed of materials that will provide the appropriate durability in the conditions in which the strainer 20 is employed. For example, the parts of the strainer assembly 20 may be formed of polymeric materials, such as polyvinyl chloride or chlorinated polyvinyl chloride, or metals, such as stainless steel, and can be coated with corrosion-resistant or other performance enhancing coatings that increase the working life and performance of the strainer 20 in the chosen environment.

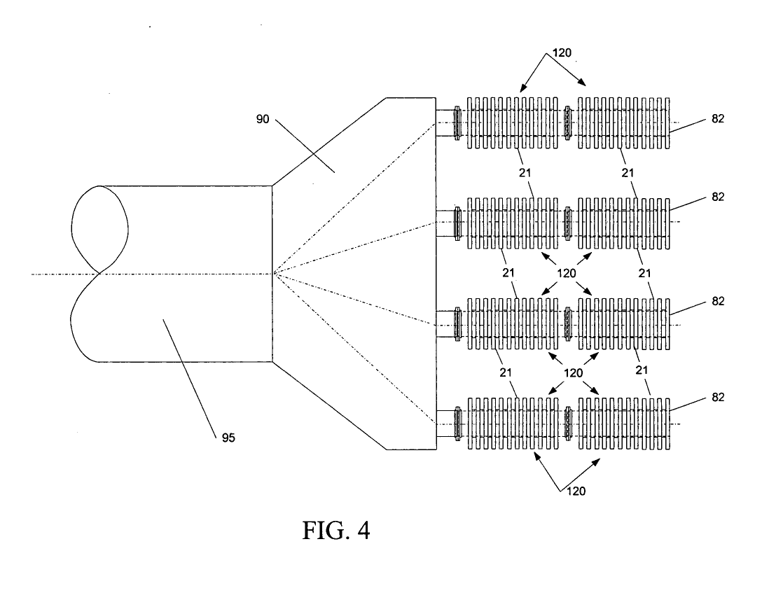

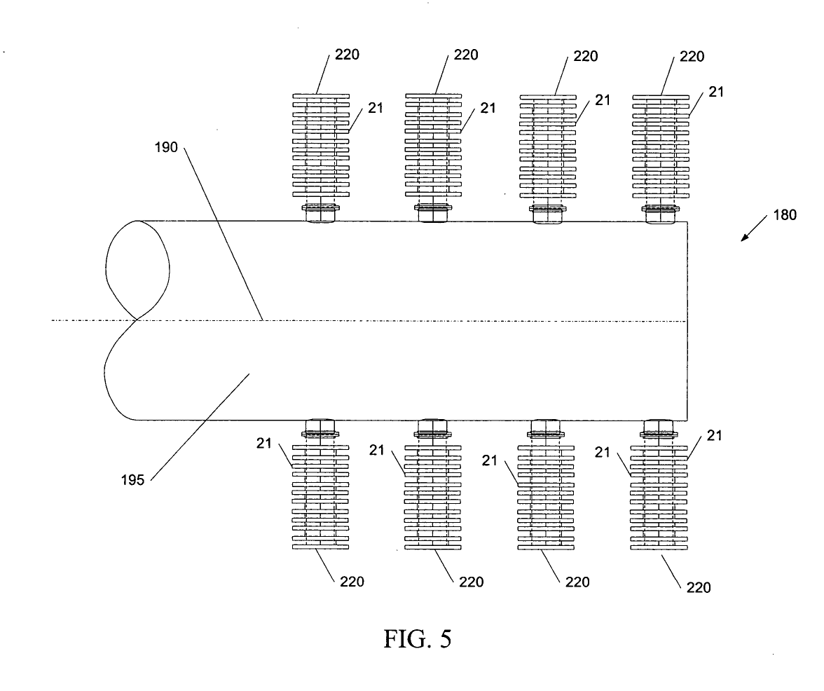

FIGS. 4 and 5 illustrate two alternative embodiments of suction strainer systems encompassed by the present invention. FIG. 4 illustrates a suction strainer system 80 in flow communication with the inlet 90 of a suction pipe 95. The suction strainer system 80 includes four series 82 of strainer assemblies 120. Each series 82 includes two strainer assemblies 120 connected in series. The four series 82 are aligned in parallel feeding into the inlet 90 of the suction pipe 95. Each strainer assembly 120 includes twelve strainer bodies 21 having flow control apertures, primary openings and secondary openings as described above.

FIG. 5 shows a strainer system 180 including eight strainer assemblies 220 connected in parallel to the inlet 190 of a suction pipe 195. Each strainer assembly 220 includes twelve strainer bodies 21 containing features as shown in FIGS. 1-3. The aggregate area of flow control apertures can be the same from one strainer assembly 220 to the next or can increase from one to the next moving upstream along the suction pipe 95.

In use, the strainer assembly 20 is connected to the suction inlet 40 of a suction pump and partially or completely submerged in a fluid, such as water in a river, pond, or lake. The suction pump is activated, thereby creating a negative pressure or suction in the suction inlet 40 and the flow line and strainer bodies 21 of the strainer assembly 20. Fluid is suctioned into the internal chambers of each strainer body 21 though the screen plates 34 and the flow control apertures 51 on each flow control plate 30 and 32. The negative pressure or suction at each flow control aperture 51 varies with its distance from the suction inlet 40 and the primary opening 56 in the particular strainer body 21. The flow control apertures 51 are sized and aligned in each strainer body 21 so that the intake velocity of the fluid is generally uniform across the entire expanse of each strainer body 21. And where the aggregate area of the flow control apertures 51 increase in each strainer body 21 distally from the suction inlet 40, the fluid intake velocity generally is uniform across the entire extent of the strainer assembly 20. The screen plates 34 prevent solids of a predetermined size from being suctioned with the fluid into the internal chambers of the strainer bodies 21. Fluid is suctioned into the internal chamber of a suction body 21 and then sucked through the primary opening 56 of the first flow control plate 30 and then through the downstream gap rims 26. The fluid then travels in turn through the secondary openings 58 and the primary openings 56 of each downstream strainer body 21 until it reaches the suction inlet 40.

Although the strainer assembly 20 shown in FIGS. 1-3 includes strainer bodies 21 that each include a first flow control plate 30 and a second flow control plate 32 separated by a rim 24 and enclosed by screen plates 34 and end plate 28, other configurations are contemplated and encompassed by the present invention. For example, instead of a rim and plate spacers connecting the two flow control plates, the flow control plates can be formed as concave portions of a shell that connect directly to each other and still define an internal chamber into which fluid can be drawn. In the embodiment shown in FIG. 3, each series 54 of flow control apertures extends radially away from the primary and secondary openings 56 and 58, which are shown as being centrally aligned in flow control plates 30 and 32, respectively. However, the flow control plates can have alternative configurations. For example, the primary and secondary openings can be offset from center. The flow control apertures can be more randomly distributed across the flow control plate in such a way as to still provide increasing aperture area distally from the primary opening, such as by increasing the number of apertures moving away from the primary opening.

Also, in another embodiment, the screen plates can be formed directly on the flow control plates and extend across each of the flow control apertures. In other alternative embodiments, a core tube can be provided to extend through the interiors of all strainer bodies 21 in a strainer assembly 20 and connect the bodies to the suction inlet of the pump. The core tube can include intake holes formed along its length through which fluid is drawn from the interior of the strainer bodies. The core tube holes can be sized and aligned to provide flow control characteristics, such as by providing holes of increasing area moving distally from the suction inlet. When a core tube is provided to collect fluid from each strainer body 21 at the same flow rate, the flow control apertures in flow control plates 30 and 32 generally have the same aggregate area in each strainer body 21 of the strainer assembly 20, in order to maintain the desired uniform flow. These and other embodiments are encompassed by the present invention.

While certain embodiments of the present invention have been disclosed herein, other embodiments of the present invention will suggest themselves to persons skilled in the art in view of this disclosure. Therefore, it will be understood that variations and modifications can be effected within the spirit and scope of the invention and that the scope of the present invention should only be limited by the claims below. It is also understood that any relative relationships and dimensions shown on the drawings are given as example relative relationships and dimensions, but the scope of the invention is not to be limited thereby.

What is claimed is:

1. A strainer assembly comprising:
a strainer body defining an internal chamber and having a primary opening formed therein, said strainer body comprising a wall encompassing at least a portion of said internal chamber, said wall including a series of flow control apertures formed therein, wherein said series of flow control apertures comprises at least a first flow control aperture proximate to said primary opening and a second flow control aperture distal to said primary opening, wherein said second flow control aperture has an area greater than the area of said first flow control aperture, and wherein said first flow control aperture and said second flow control aperture are covered by screen.

2. The strainer assembly of claim 1, wherein said wall comprises a flow control plate having at least one of said first flow control aperture and said second flow control aperture formed therein.

3. The strainer assembly of claim 1, wherein each flow control aperture in said series of flow control apertures has an area greater than the area of each flow control aperture in said series that is proximate to said primary opening.

4. The strainer assembly of claim 2, wherein said primary opening is centrally aligned in said flow control plate and said series of flow control apertures is radially aligned with said primary opening.

5. The strainer assembly of claim 2, wherein said flow control plate further comprises a standoff formed thereon separating said screen from said flow control apertures.

6. The strainer assembly of claim 1, wherein said wall comprises a first flow control plate and a second flow control plate.

7. The strainer assembly of claim 6, wherein each of said first flow control plate and said second flow control plate comprises a plurality of flow control apertures formed therein.

8. The strainer assembly of claim 7, wherein said primary opening is formed in said first flow control plate.

9. The strainer assembly of claim 8, wherein said second flow control plate comprises a secondary opening formed therein.

10. The strainer assembly of claim 9, wherein said primary opening and said secondary opening are axially coaligned.

11. The strainer assembly of claim 9, wherein said plurality of flow control apertures of said first flow control plate are radially aligned with said primary opening and said plurality of flow control apertures of said second flow control plate are radially aligned with said secondary opening.

12. The strainer assembly of claim 6, wherein said first flow control plate and said second flow control plate are supported by a tension rod.

13. The strainer assembly of claim 6, wherein said wall further comprises a rim disposed between said first and second flow control plates.

14. The strainer assembly of claim 13, wherein said rim includes flow control apertures formed therein.

15. The strainer assembly of claim 6, further comprising a first screen plate aligned with said first flow control plate and a second screen plate aligned with said second flow control plate.

16. A strainer assembly comprising:
a strainer body comprising:
a first flow control plate having a primary opening and a first plurality of flow control apertures formed therein, wherein a collective area of said first plurality flow control apertures increases distally from said primary opening; and,
a second flow control plate connected to said first flow control plate and having a secondary opening and a second plurality of flow control apertures formed therein, wherein a collective area of said second plurality of flow control apertures increases distally from said secondary opening.

17. The strainer assembly of claim 16, further comprising a screen extending across said first plurality of flow control apertures and said second plurality of flow control apertures.

18. The strainer assembly of claim 17, wherein said screen comprises a first screen plate aligned with said first flow control plate and a second screen plate aligned with said second flow control plate.

19. The strainer assembly of claim 16, wherein said first flow control plate and said second flow control plate are supported by at least one tension rod.

20. The strainer assembly of claim 16, wherein the collective area of said first plurality of flow control apertures over a defined unit area increases distally from said primary opening.

21. The strainer assembly of claim 16, wherein the collective area of said second plurality of flow control apertures over a defined unit area increases distally from said secondary opening.

22. A suction strainer system comprising the strainer assembly of claim 16 connected in series to a second strainer assembly.

23. A suction strainer system comprising the strainer assembly of claim 16 connected parallel to a second strainer assembly.

24. A suction strainer system for connection to an inlet of a suction pipe comprising:
a plurality of strainer assemblies in flow communication with said inlet of said suction pipe, wherein at least one strainer assembly of said plurality of strainer assemblies comprises:
a strainer body defining a first internal chamber and having a primary opening formed therein, said strainer body having a wall encompassing at least a portion of said first internal chamber, said wall including a first plurality of flow control apertures formed therein, wherein the collective area of said first plurality of flow control apertures over a defined unit area increases distally from said primary opening.

25. The suction strainer system of claim 24, wherein said plurality of strainer assemblies are sequentially aligned along a flow line to said inlet.

26. The suction strainer system of claim 25, wherein said internal chamber of said strainer body forms a portion of said flow line.

27. The suction strainer system of claim 21, wherein each of said plurality of strainer assemblies comprises a series of flow control apertures formed therein and wherein the aggregate area of each of said flow control apertures of each of said plurality of strainer assemblies increases distally from said inlet.

28. The suction strainer system of claim 24, wherein said strainer body comprises a secondary opening formed therein, upstream of said primary opening.

29. The suction strainer system of claim 28, wherein said plurality of strainer assemblies comprises a second strainer assembly comprising a strainer body defining a second internal chamber and having a primary opening formed therein, wherein said primary opening is upstream of said secondary opening of said first strainer assembly.

30. The suction strainer system of claim 29, wherein said strainer body of said second strainer assembly comprises a second plurality of flow control apertures formed therein and wherein the collective area of said second plurality of flow control apertures in defined unit area increases distally from said primary opening of said body of said second strainer assembly.

31. The suction strainer system of claim 24, wherein said strainer body comprises a first flow control plate and a second flow control plate.

32. The suction strainer system of claim 31, wherein said primary opening of said first strainer assembly is formed in said first flow control plate and a secondary opening is formed in said second flow control plate.

33. The suction strainer system of claim 32, wherein said first flow control plate includes a plurality of flow control apertures radially aligned with said primary opening, wherein the collective area of said flow control apertures over a defined unit area increases distally from said primary opening.

34. The suction strainer system of claim 24, wherein said first strainer body comprises a screen extending across said flow control apertures.

35. The suction strainer system of claim 24, wherein said plurality of strainer assemblies are connected in series.

36. The suction strainer system of claim 24, wherein said plurality of strainer assemblies are connected in parallel.

37. A suction strainer system for connection to a suction inlet of a pump, said strainer assembly comprising:
a plurality of strainer assemblies in flow communication with the suction inlet, wherein each strainer assembly of said plurality of strainer assemblies comprises:
a strainer body defining a internal chamber and comprising a first flow control plate and a second flow control plate, said first flow control plate having a primary opening and a first plurality of flow control apertures, wherein the collective area of said first plurality of flow control apertures over a defined unit area increases distally from said primary opening, wherein said second flow control plate has a second plurality of flow control apertures formed therein and a secondary opening, and wherein the collective area of said second plurality of flow control apertures over a defined unit area increases distally from said secondary opening.

38. The suction strainer system of claim 37, wherein screen extends across said first and second pluralities of flow control apertures of each strainer body.

39. The suction strainer system of claim 37, wherein the aggregate area of flow control apertures in each strainer body increases distally from said suction inlet.

40. A strainer assembly comprising a plurality of flow control apertures formed therein, said flow control apertures being so sized and arranged that fluid flowing into the strainer assembly exhibits a substantially uniform approach velocity through substantially all of said plurality of flow control apertures.

41. A strainer assembly for taking in fluid at a plurality of fluid entry locations and straining debris from the fluid, the assembly including a plurality of strainer bodies and being characterized by a uniform approach velocity achieved at substantially all fluid entry locations along the strainer assembly.
